(19) United States
(12) Patent Application Publication
(10) Pub. No.: US 2013/0052887 A1
(43) Pub. Date: Feb. 28, 2013

(54) TERMINAL STRUCTURE OF WIRING HARNESS

(71) Applicants: Masato Inoue, Yokkaichi-shi (JP); Kazunari Sakura, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Tsubasa Nishida, Yokkaichi-shi (JP); Kazuo Nakashima, Yokkaichi-shi (JP); Hideki Imamura, Yokkaichi-shi (JP)

(72) Inventors: Masato Inoue, Yokkaichi-shi (JP); Kazunari Sakura, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Tsubasa Nishida, Yokkaichi-shi (JP); Kazuo Nakashima, Yokkaichi-shi (JP); Hideki Imamura, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/505,395

(22) PCT Filed: Jul. 4, 2011
(86) PCT No.: PCT/JP2011/065294

§ 371 Date: May 17, 2012

(30) Foreign Application Priority Data
Jul. 23, 2010 (JP) 2010-165430

(51) Int. Cl. H01R 4/18

(52) U.S. Cl. 439/877

(57) ABSTRACT

Disclosed is a terminal structure of a wiring harness for automobile use that has a profound anticorrosive effect. A terminal member is fixed to an end portion of a coated electric wire such that a crimping portion that the member includes at its one end is crimped around an outer surface of a coating portion of the wire. A resin member is formed to completely cover at least entire outer surfaces of an exposed region at an end portion of the crimping portion (a region including a fracture cross section and a root edge portion) and a region in the vicinity thereof. The resin member is made mainly of an epoxy resin, and a cured material obtained by curing a material having a viscosity from 1000 to 30000 mPa·s at 25 degrees C., which is measured in accordance with the JIS Z8803.

### TECHNICAL FIELD

The present invention relates to a terminal structure of a wiring harness for automobile use.

### BACKGROUND ART

Conventionally, a structure of a terminal connecting portion of a coated electric wire cited in PTL 1, for example, is used for a structure, which is waterproofed by resin molding, of a terminal portion of a wiring harness to which a corresponding terminal member is fixed.

The resin molded terminal connecting portion of the coated electric wire cited in PTL 1 is prepared by injecting a molten molding resin into a molding cavity space that is provided in a mold consisting of upper and lower molds. The molding cavity space defines a cavity for molding, in which the terminal connecting portion that is prepared by crimping a terminal member on a conductor at an end portion of the coated electric wire is housed and set for injection.

Thus, the terminal connecting portion of the coated electric wire cited in PTL 1, in which the terminal portion of the wiring harness is resin molded, produces a consistent waterproof effect and anticorrosive effect.

### CITATION LIST

### Patent Literature

PTL1: JP3627846B

### SUMMARY OF INVENTION

### Technical Problem

However, in the terminal connecting portion of the coated electric wire cited in PTL 1, the molding resin is applied on a back surface of the terminal member merely to the extent of not hindering flatness of the back surface because the terminal member is installed on a flat surface such as an automobile body.

Thus, there arises a problem that because the back surface of the terminal member is not molded of the resin completely, a sufficient anticorrosive effect cannot be produced there.

In order to solve the problem described above, an object of the present invention is to provide a terminal structure of a wiring harness for automobile use that has a profound anticorrosive effect.

### Solution to Problem

The terminal structure of the wiring harness for automobile use of the present invention includes a coated electric wire including a plurality of bare conductors, a coating portion with which the bare conductors are coated and an exposed portion at an end of the electric wire where portions of the conductors are exposed, a terminal member that is fixed to the coated electric wire and includes a crimping portion at its one end that is fixed to the coated electric wire by being crimped around an outer surface of the coating portion of the electric wire in the vicinity of the exposed portion, and a resin member that covers at least an entire outer surface of an exposed region at an end portion of the crimping portion, and an entire outer surface of a region in the vicinity of the exposed region, wherein the resin member is made of an epoxy resin as a main ingredient, and a cured material that is obtained by curing a material that has a viscosity within a range of 1000 to 30000 mPa·s at 25 degrees C., which is measured in accordance with the JIS Z8803.

It is preferable that the terminal member includes a plated region that defines a surface that is coated with plating, and that the exposed region at the end portion of the crimping portion includes a no-plated region that is uncoated with plating.

It is preferable that the bare conductors are made of a material containing aluminum, the terminal member is made of a material containing copper, and a material of the plating for the plated region contains tin.

### Advantageous Effects of Invention

In the present invention, because the resin member covers the entire outer surface of the exposed region at the end portion of the crimping portion and the entire outer surface of the region in the vicinity of the exposed region, a risk that an electrolytic solution enters from the exposed region at the end portion of the crimping portion and erodes the material of the crimping portion to finally erode a portion of the bare conductors can be avoided in a convincing way. Further, being made of the epoxy resin as the main ingredient, and the cured material that is obtained by curing the material that has the viscosity within the range of 1000 to 30000 mPa·s at 25 degrees C., which is measured in accordance with the JIS Z8803, the resin member can contribute to improvement in anticorrosive performance from the view point of materials.

As a result, the terminal structure of the wiring harness for automobile use has an enhanced anticorrosive effect.

If the terminal member includes the plated region that defines the surface that is coated with plating, and the exposed region at the end portion of the crimping portion includes the no-plated region that is uncoated with plating, the resin member can avoid a risk in a convincing way that an electrolytic solution enters from the exposed region at the end portion of the crimping portion to finally erode a portion of the bare conductors.

Thus, even though the exposed region at the end portion of the crimping portion includes the no-plated region that is uncoated with plating because of a processing treatment to produce the crimping portion, the exposed region need not be coated with plating again, which can lower the cost of production for the terminal member including the crimping portion.

In addition, the combined use of the copper of which the terminal member is made and the aluminum of which the bare conductors are made could cause high-rate consecutive erosion over the terminal member and the bare conductors; however, the resin member can avoid in a convincing way a risk that an electrolytic solution enters from the exposed region to finally erode a portion of the bare conductors.

Because the terminal member is made of copper that is a favorable material for the terminal member, and the bare conductors are made of aluminum that is a favorable material for the bare conductors in this case, the terminal structure of the wiring harness can be made easy to use.

### BRIEF DESCRIPTION OF DRAWINGS

FIG. 1 is a view schematically showing a cross section structure of a terminal of a wiring harness for automobile use of a preferred embodiment of the present invention.

FIG. 2 is a view showing size properties of the terminal of the wiring harness of the present embodiment.

FIG. 3 is a cross-sectional view showing the terminal along the line A-A of FIG. 2.

FIG. 4 is a view for illustrating an effect achieved by the present embodiment.

FIG. 5 is a view schematically showing another preferred embodiment of the present invention.

FIG. 6 is a view showing a conventional terminal structure of a wiring harness that corresponds to the present embodiment.

FIG. 7 is a view for illustrating a corrosion testing method used in Example.

### DESCRIPTION OF EMBODIMENTS

### Preferred Embodiment

### Structure

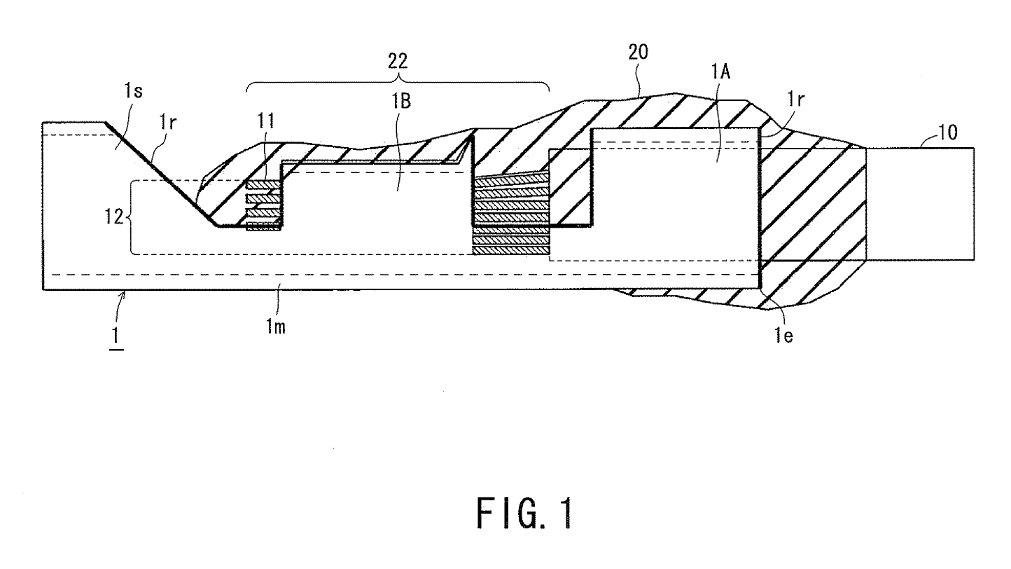

FIG. 1 is a view schematically showing a cross section structure of a terminal of a wiring harness for automobile use of a preferred embodiment of the present invention.

As shown in FIG. 1, a coated electric wire 10 including a plurality of bare conductors 11 and a coating portion 13 (not shown) with which the bare conductors 11 are insulation coated includes an exposed portion 22 at its end where a portion of a conductor group 12 consisting of the plurality of bare conductors 11 is exposed. The bare conductors 11 are made preferably of aluminum.

A terminal member 1 is fixed to a terminal portion of the coated electric wire 10. To be specific, the terminal member 1 is fixed to the terminal portion of the coated electric wire 10 such that a crimping portion 1A, which the terminal member 1 includes at its one end, is crimped around an outer surface of the coating portion of the coated electric wire 10, and a crimping portion 1B, which the terminal member 1 includes at a position inner than the crimping portion 1A, is crimped around an outer surface of the conductor group 12 at the exposed portion 22 in a terminal region of the coated electric wire 10. The terminal member 1 is made preferably of brass or a copper alloy.

The terminal member 1 includes a plated region 1m that is prepared in advance by coating a surface of the terminal member 1 with tin plating, while a fracture cross section 1r exists on a surface of the terminal member 1 where the copper is exposed, which is exposed during a processing treatment to produce the crimping portions 1A and 1B. A surface portion of the fracture cross section 1r is indicated with a thick line in FIG. 1.

A resin member 20 is formed so as to completely cover at least an entire outer surface of an exposed region at an end portion of the crimping portion 1A (a region including the fracture cross section 1r and a root edge portion 1e shown in the right part of FIG. 1), and an entire outer surface of a region in the vicinity of the exposed region. Further, the resin member 20 is formed over an upper region of the terminal member 1 from the crimping portion 1A to the exposed portion 22 and the crimping portion 1B. The resin member 20 is preferably a molded object prepared in a molding method, considering that size setting can be easily controlled. The resin member 20 can be molded also by a falling-drop method, a coating method or an extrusion method.

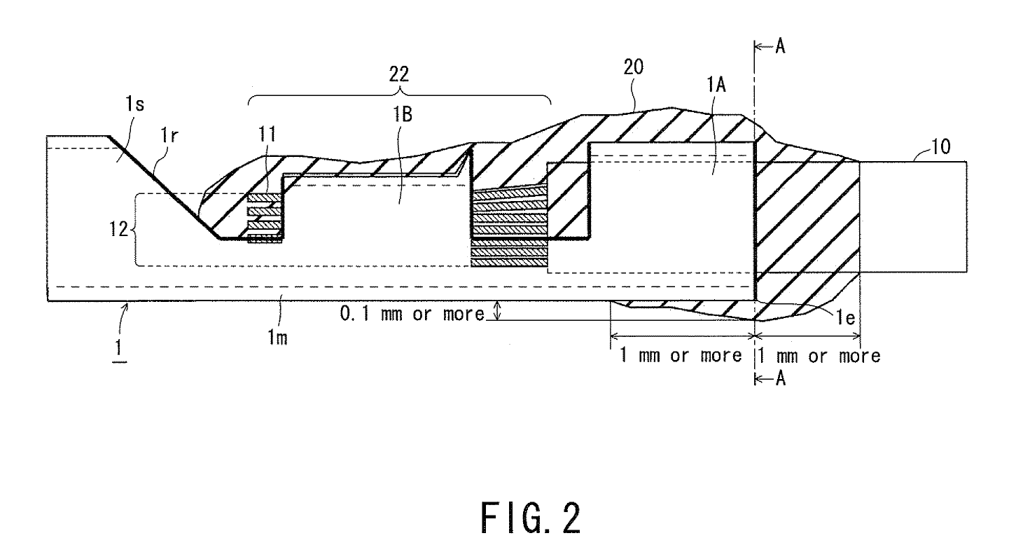

FIG. 2 is a view showing size properties of the terminal structure of the wiring harness of the present embodiment. The resin member 20 is formed 1 mm or more long in a direction to one end of the terminal member 1 (a direction to the coated electric wire 10 ) from the root edge portion le of the exposed region at the end portion on a back surface of the crimping portion 1A, and the resin member 20 is formed 1 mm or more long in a direction to the other end of the terminal member 1 (a direction to the crimping portion 1B and the conductor group 12) as shown in FIG. 2. In addition, the thickness of the resin member 20 at the root edge portion le is set to be 0.1 mm or more.

Thus, the formed resin member 20 completely covers the root edge portion 1e, and has the size properties with which an adverse effect of eroding the tin that is the plating material of the plated region 1m can be avoided completely.

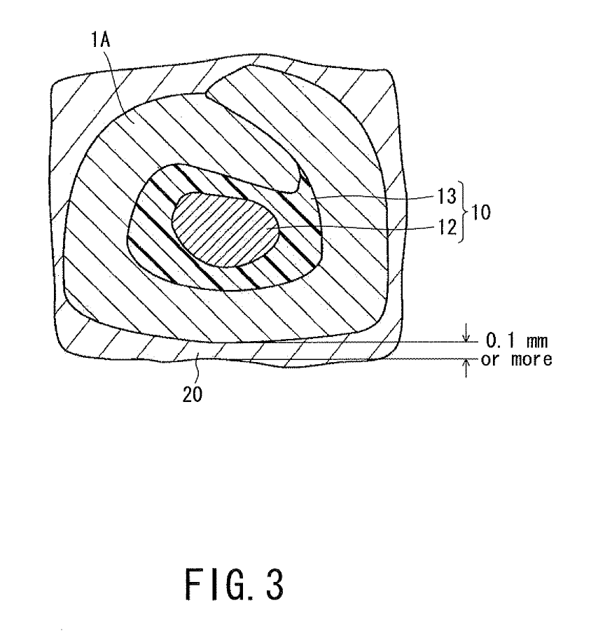

FIG. 3 is a cross-sectional view showing the terminal along the line A-A of FIG. 2. The resin member 20 is, as shown in FIG. 3, formed so as to completely cover the entire outer surface of the crimping portion 1A in section along the line A-A of FIG. 2 (in section at the one end of the terminal member 1 (the crimping portion 1A)). To be specific, the resin member 20 having the thickness of 0.1 mm or more is formed so as to cover the entire outer surface of the crimping portion 1A. The coated electric wire 10 includes the conductor group 12 and the coating portion 13 with which the conductor group 12 is coated as shown in FIG. 3.

In the terminal structure of the wiring harness of the present embodiment, the resin member 20 is made of an epoxy resin as a main ingredient. The epoxy resin may be a one-component epoxy resin or a two-component epoxy resin. When the one-component epoxy resin is used, a mixing step is unnecessary unlike the two-component epoxy resin, which leads to improvement in productivity of the terminal structure of the wiring harness.

Examples of the epoxy resin include a bisphenol A epoxy resin, a bisphenol F epoxy resin and a bisphenol AD epoxy resin that are made of phenols, an aliphatic epoxy resin made of alcohols, an epoxy resin made of amines, and a cresol novolac epoxy resin made of o-cresol novolac resin.

The material of the resin portion may consist of one epoxy resin alone, or may consist of two or more kinds of epoxy resins. Further, the material of the resin portion may contain additives and other polymers as appropriate within a range of not impairing its physical properties.

A general additive used for a material for resin molding is used as the additive for the material of the resin portion, which is not limited specifically. Examples of the additive include a curing agent, an inorganic filler, an antioxidant, a metal deactivator (a copper inhibitor), an ultraviolet absorber, an ultraviolet-concealing agent, a flame-retardant auxiliary agent, a processing aid (e.g., a lubricant, wax), carbon and other coloring pigments, a flexibilizer, an agent providing shock resistance, an organic filler, a dilution agent (e.g., a solvent), a thixotropic agent, coupling agents of various kinds, a defoamer, and a levelling agent.

The material of the resin portion is an uncured material, and cured after applied in order to increase mechanical strength of the resin portion. A curing method is not limited specifically. Examples of the curing method include a moisture curing method, a thermal curing method and a chemical curing method.

The material of the resin portion has a viscosity within a range of 1000 to 30000 mPa·s at 25 degrees C., which is measured in accordance with the JIS Z8803. A rotating viscometer is preferably used as a viscometer in the measurement.

If the viscosity is less than 1000 mPa·s, the material flows out when applied, which makes it difficult to provide a sufficient amount of the material of the resin port ion on a portion where an anticorrosion property is required. Thus, the terminal structure of the wiring harness cannot easily achieve an enhanced anticorrosive effect. The lower limit of the viscosity is preferably 1500 mPa·s. On the other hand, if the viscosity is more than 30000 mPa·s, the material does not flow out when applied, which makes it difficult to provide a sufficient amount of the anticorrosive material on the portion where an anticorrosion property is required. Thus, the terminal structure of the wiring harness cannot easily achieve an enhanced anticorrosive effect. The upper limit of the viscosity is preferably 25000 mPa·s from the viewpoint of productivity and anticorrosive performance.

### Comparison with Conventional Structure

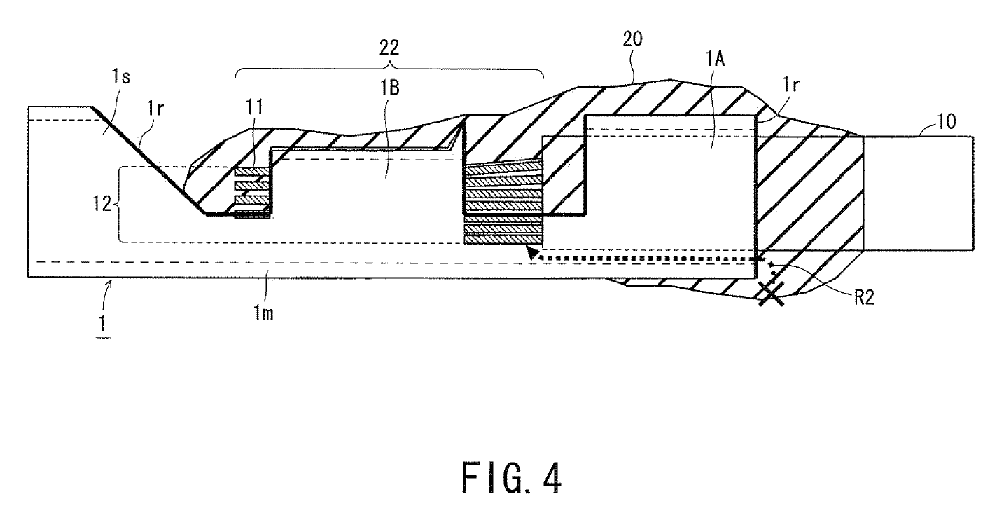

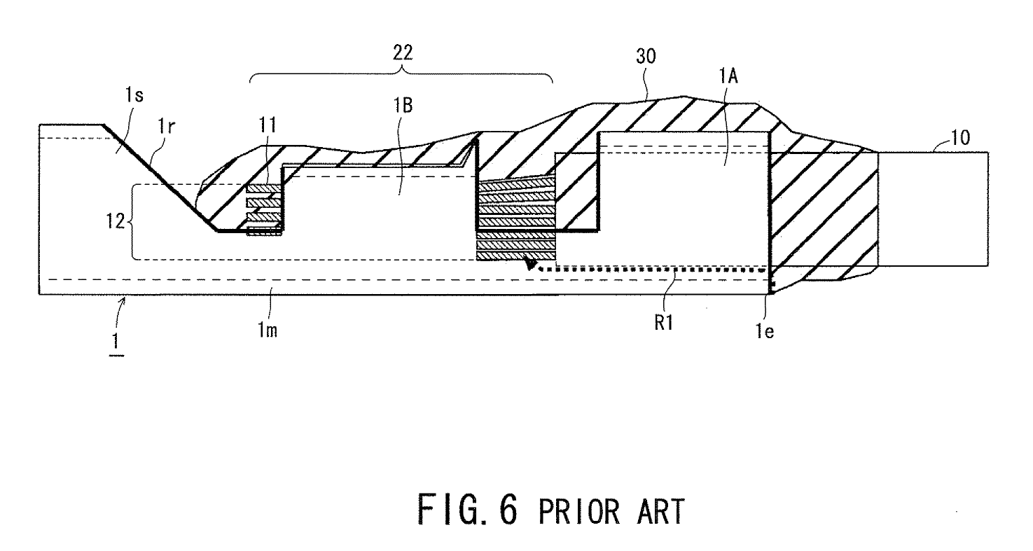

FIGS. 4 and 6 are views for illustrating an effect of the present embodiment. FIG. 4 is a view showing the terminal structure of the wiring harness of the present embodiment. FIG. 6 is a view showing a conventional terminal structure of a wiring harness that corresponds to the present embodiment.

A description of the structure shown in FIG. 4 is omitted because it is same as the descriptions provided above referring to FIGS. 1 to 3. In the conventional terminal structure shown in FIG. 6, a resin member 30 is formed so as to cover a back surface of the coated electric wire 10 until the root edge portion le of the crimping portion 1A. However, not formed on the back surface of the crimping portion 1A, the resin member 30 is not formed so as to completely cover the region including the root edge portion 1e.

Because of this, a possibility cannot be avoided in a convincing way such that an electrolytic solution such as seawater enters from the root edge portion 1e, and while eroding the brass or the copper alloy of which the terminal member 1 (the crimping portion 1A) is made and the tin that is plated on the terminal member 1, and enters through a path R1 of the electrolytic solution. As a result, when the electrolytic solution reaches the conductor group 12 through the path R1, the aluminum of which the bare conductors 11 are made is eroded because the aluminum has a stronger ionization tendency than the brass and the copper alloy of which the terminal member 1 is made.

As described above, the resin member 30 of the conventional terminal structure of the wiring harness, as cited in PTL 1, for example, does not completely cover the root edge portion le of the crimping portion 1A, so that the path R1 cannot be interrupted completely. As a result, a possibility of erosion of the bare conductors 11 is raised.

Meanwhile, in the terminal structure of the wiring harness of the present embodiment 1, the resin member 20 is formed so as to completely cover the entire outer surface of the exposed region at the end portion of the crimping portion 1A that includes the root edge portion le as shown in FIG. 4 (and FIGS. 1 to 3). Thus, a virtual path R2 of the electrolytic solution that extends from the fracture cross section 1r at the one end of the terminal member 1 can be interrupted completely as shown in FIG. 4.

As described above, in the terminal structure of the wiring harness of the present embodiment, the resin member 20 completely cover the entire outer surface of the exposed region at the end portion of the crimping portion 1A that is defined as the fracture cross section 1r, and the entire outer surface of the region in the vicinity of the exposed region, so that a risk that an electrolytic solution enters from the fracture cross section it (the root edge portion le) that defines the exposed region and erodes the brass or the copper alloy of the crimping portion 1A and the tin plated on the crimping portion 1A to finally erode a portion of the bare conductors 11 can be avoided in a convincing way.

Further, being made of the epoxy resin as the main ingredient, and the cured material that is obtained by curing the material that has the viscosity within the range of 1000 to 30000 mPa·s at 25 degrees C., which is measured in accordance with the JIS Z8803, the resin member 20 can contribute to improvement in anticorrosive performance from the view point of materials.

As a result, an effect of obtaining the terminal structure of the wiring harness for automobile use that has a profound anticorrosive effect is achieved. Thus, the bare conductors 11 can maintain their stable electric performance.

In addition, though the exposed region at the end portion of the crimping portion 1A includes the no-plated region (the fracture cross section 1r) that is not the plated region 1m, the resin member 20 formed as described above can avoid in a convincing way a risk that an electrolytic solution enters from the exposed region to finally erode a portion of the bare conductors.

Thus, even though the exposed region at the end portion of the crimping portion 1A includes the fracture cross section 1r that is uncoated with plating because of a processing treatment to produce the crimping portion 1A from the terminal member 1, the exposed region need not be coated with plating again, which can lower the cost of production for the terminal member 1 including the crimping portion 1A.

In addition, the combined use of the brass or the copper alloy of which the terminal member 1 is made and the aluminum of which the bare conductors 11 are made could cause high-rate consecutive erosion over the terminal member 1 and the bare conductors 11; however, the resin member 20 formed as described above can avoid in a convincing way a risk that an electrolytic solution enters from the exposed region to finally erode a portion of the bare conductors 11.

As a result, because the terminal member 1 is made of copper that is a favorable material for the terminal member 1, and the bare conductors 11 are made of aluminum that is a favorable material for the bare conductors 11, the terminal structure of the wiring harness can be made easy to use.

### Another Preferred Embodiment

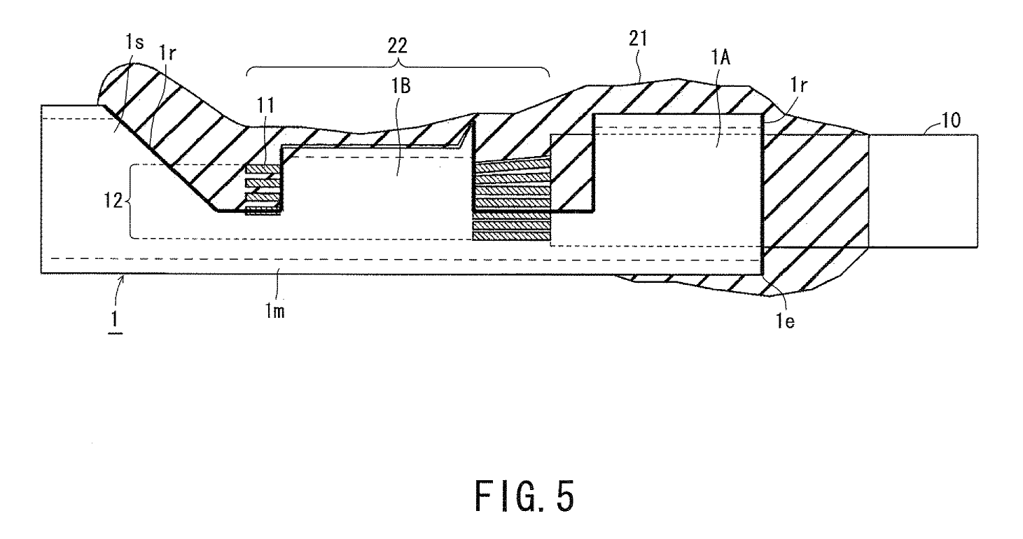

FIG. 5 is a view schematically showing another preferred embodiment of the present invention. In the present embodiment, a resin member 21 is formed also on a fracture cross section 1r at the other end is of the terminal member 1 as shown in FIG. 5. The resin member 21 is formed also on portions same as the resin member 20 shown in FIGS. 1 to 4. The structure of the present embodiment is same as the structure shown in FIGS. 1 to 4, except that the resin member 30 is replaced with the resin member 21.

The configuration of the resin member 21 formed also on the fracture cross section 1r at the other end is of the terminal member 1 as shown in FIG. 5 can enhance such an effect of preventing erosion of the bare conductors 11 to be caused by an electrolytic solution that enters from the fracture cross section 1r at the other end 1s.

As described above, in the terminal structure of the wiring harness of the present embodiment, the resin member 21 is provided to all of the fracture cross sections 1r (no-plated regions) of the terminal member 1, so that an effect of preventing erosion of the bare conductors 11 to be caused by erosion of the brass or the copper alloy of the terminal member 1 can be enhanced.

### EXAMPLE

A description of the present invention will now be specifically provided with reference to Examples. It is to be noted that the present invention is not limited to Examples.

### 1. Preparation of Coated Electric Wire

A polyvinyl chloride composition was prepared as follows: 100 parts by mass of polyvinyl chloride (polymerization degree of 1300), 40 parts by mass of diisononylphthalate that defines a plasticizer, 20 parts by mass of calcium carbonate heavy that defines a filler, and 5 parts by mass of a calcium-zinc stabilizer that defines a stabilizer were mixed at 180 degrees C. in an open roll, and the mixture was formed into pellets with the use of pelletizer.

Then, a conductor group (having a cross-sectional area of 0.75 mm) that defines an aluminum alloy strand that was made up of seven aluminum alloy wires was extrusion-coated with the polyvinyl chloride composition prepared as above such that the coat had a thickness of 0.28 mm with the use of 50 mm extruder. Thus, coated electric wires (PVC electric wires) were prepared.

### 2. Crimp of Terminal Member and Formation of Resin Member

The coat was peeled off at an end of each coated electric wire to expose each wire conductor group, and then a male crimping terminal member (0.64 mm in width at a tub, the member including a crimping portion at the conductor group and a crimping portion at the coating portion) made of brass generally used for automobile was crimped onto the end of each coated electric wire.

Then, each of materials for resin members of different kinds that are to be described later was applied over the crimping portion at the coating portion and the crimping portion at the conductor group of each terminal member so as to coat an outer surface of an exposed region at an end portion of the crimping portion at the coating portion, and an outer surface of a region in the vicinity of the exposed region. Then, the resins were subjected to curing treatment for the duration of respective times under the respective curing conditions in a constant temperature bath. The each resin was applied to be 0.1 mm in thickness and cured.

### Example 1

One-component epoxy resin (A) [manuf.: THREEBOND CO., LTD., trade name: “2212C”, viscosity at 25 degrees C.: 25000 mPa·s, curing conditions: 80 degrees C. for 30 minutes]

### Example 2

One-component epoxy resin (B) [manuf.: THREEBOND CO., LTD., trade name: “2212”, viscosity at 25 degrees C.: 13000 mPa·s, curing conditions: 90 degrees C. for 30 minutes]

### Example 3

One-component epoxy resin (C) [manuf.: THREEBOND CO., LTD., trade name: “2210”, viscosity at 25 degrees C.: 8000 mPa·s, curing conditions: 90 degrees C. for 30 minutes]

### Example 4

One-component epoxy resin (D) [manuf.: AJINOMOTO FINE-TECHNO CO., INC., trade name: “PLENSET AE-400”, viscosity at 25 degrees C.: 10000 mPa·s, curing conditions: 80 degrees C. for 30 minutes]

### Example 5

One-component epoxy resin (E) [manuf.: AJINOMOTO FINE-TECHNO CO., INC., trade name: “PLENSET AE-15”, viscosity at 25 degrees C.: 2000 mPa·s, curing conditions: 80 degrees C. for 30 minutes]

### Example 6

Two-component epoxy resin (F) [manuf.: TAOKA CHEMICAL CO., LTD., trade name: “TECHNODYNE AH6021W”, viscosity at 25 degrees C.: 15000 mPa·s, curing conditions: 80 degrees C. for 60 minutes]

### Comparative Example 1

One-component epoxyresin (a) [manuf.: THREEBOND CO., LTD., trade name: “2212E”, viscosity at 25 degrees C.: 35000 mPa·s, curing conditions: 90 degrees C. for 30 minutes]

### Comparative Example 2

One-component epoxy resin (b) [manuf.: AJINOMOTO FINE-TECHNO CO., INC., trade name: “PLENSET AE-901B”, viscosity at 25 degrees C.: 60000 mPa·s, curing conditions: 60 degrees C. for 30 minutes]

### Comparative Example 3

Two-component epoxy resin (c) [manuf.: TAOKA CHEMICAL CO., LTD., trade name: “TECHNODYNE AH3051K”, viscosity at 25 degrees C.: 35000 mPa·s, curing conditions: 100 degrees C. for 30 minutes]

### 3. Evaluation Procedure

Evaluations of peeling and anticorrosive performance of the resin members were performed as follows on the coated electric wires on which the resin members made of different kinds of resins were formed.

### Peeling Test

The formed resin members were scratched by a finger nail, and the resin members that were not peeled off were evaluated as PASSED, and a resin member that was peeled off was evaluated as FAILED. It is to be noted that a resin member, if peeled off, is obviously inferior in anticorrosive performance. For this reason, this test was performed prior to the following evaluations of anticorrosive performance.

### Anticorrosive Performance

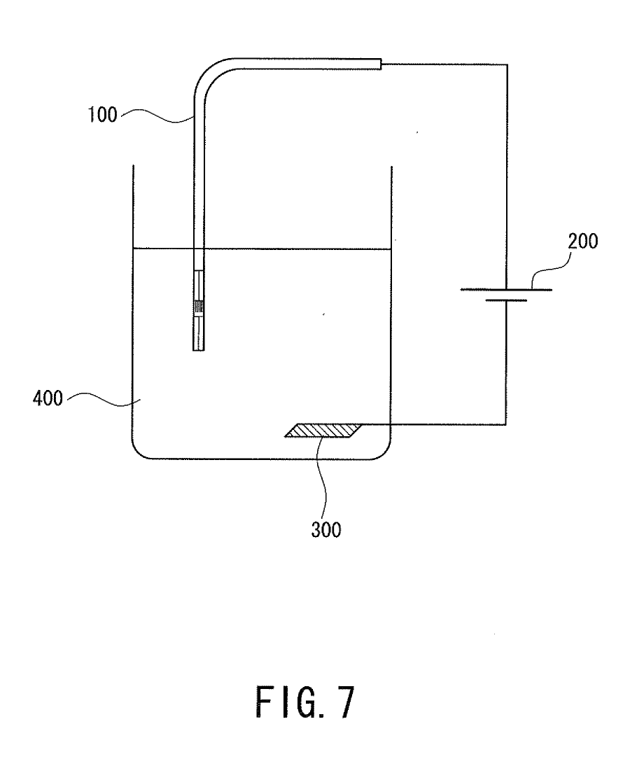

As shown in FIG. 7, each of the prepared coated electric wires 100 with the terminal members was connected to a positive electrode of an electrical power source 200 of 12 volts, while a pure copper plate 300 (1 cm in width×2 cm in length×1 mm in thickness) was connected to a negative electrode of the electrical power source 200 of 12 volts. Each of the conductor groups of the coated electric wires 100 with the terminal members and each of the crimping portions of the terminal members, and the pure copper plate 300 were immersed in 300 cc of a water solution 400 containing 5% of NaCl, and a voltage of 12 volts was applied thereto for two minutes. After the application of the voltage, ICP emission analysis of the water solution 400 was performed to measure the amount of aluminum ions eluted from the conductor group of each coated electric wire 100 with the terminal. The coated electric wires with the terminals in which the amounts of aluminum ions eluted from the wire conductors were less than 0.1 ppm were evaluated as PASSED. The coated electric wires with the terminals in which the amounts of aluminum ions eluted from the wire conductors were 0.1 ppm or more were evaluated as FAILED.

Table 1 shows the viscosities at 25 degrees C., which were measured in accordance with the JIS Z8803, and results of evaluations.

TABLE 1

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Viscosity (mPa · s) | 25,000 | 13,000 | 8,000 | 10,000 | 2,000 | 15,000 | 35,000 | 60,000 | 35,000 |
| Peeling | PASSED | PASSED | PASSED | PASSED | PASSED | PASSED | PASSED | PASSED | PASSED |
| Anticorrosive | PASSED | PASSED | PASSED | PASSED | PASSED | PASSED | FAILED | FAILED | FAILED |
| Performance | | | | | | | | | |

Table 1 shows the followings. To be specific, the resin members of Comparative Examples 1, 2 and 3, which were prepared by curing the materials having the viscosities that exceeded the specified limits of the present invention, were inferior in anticorrosive performance. It is assumed that sufficient anticorrosive performance could not be achieved because the reins did not sufficiently enter into the electric connected portions while the anticorrosive materials were in close contact with electrically connected portions without being peeled off therefrom.

Meanwhile, the resin members of present Examples were prepared by curing the materials having the viscosities that were within the specified limits of the present invention. Thus, the anticorrosive materials were in sufficiently close contact with the electrically connected portions, so that excellent anticorrosive performance could be achieved. It is assumed that because the materials of the resin members had the viscosities that were within the specified limits, the reins could sufficiently enter into the electric connected portions.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1. A terminal structure of a wiring harness for automobile use, the terminal structure comprising:
a coated electric wire comprising:
a plurality of bare conductors;
a coating portion with which the bare conductors are coated; and
an exposed portion at an end of the electric wire, where portions of the conductors are exposed;
a terminal member that is fixed to the coated electric wire, and comprises a crimping portion at its one end that is fixed to the coated electric wire by being crimped around an outer surface of the coating portion of the electric wire in the vicinity of the exposed portion; and
a resin member that covers at least an entire outer surface of an exposed region at an end portion of the crimping portion, and an entire outer surface of a region in the vicinity of the exposed region,
wherein the resin member is made of:
an epoxy resin as a main ingredient; and
a cured material that is obtained by curing a material that has a viscosity within a range of 1000 to 30000 mPa·s at 25 degrees C., which is measured in accordance with the HS Z8803.

2. The terminal structure according to claim 1, wherein the terminal member comprises a plated region that defines a surface that is coated with plating, and
wherein the exposed region at the end portion of the crimping portion comprises a no-plated region that is uncoated with plating.

3. The terminal structure according to claim 2, wherein
the bare conductors are made of a material comprising aluminum,
the terminal member is made of a material comprising copper, and
a material of the plating for the plated region comprises tin.

4. The terminal structure according to claim 1, wherein
the bare conductors are made of a material comprising aluminum,
the terminal member is made of a material comprising copper, and
a material of the plating for the plated region comprises tin.
